(19) United States
(12) Patent Application Publication
(10) Pub. No.: US 2026/0017947 A1
(43) Pub. Date: Jan. 15, 2026

(54) SYSTEM AND METHOD FOR TAGGING VIDEO BASED ON ARTIFICIAL INTELLIGENCE

(71) Applicant: CLOUDIKE INC., Gyeonggi-do (KR)

(72) Inventors: SUN UNG LEE, Seoul (KR); SEUNG HWA LEE, Gyeonggi-do (KR)

(21) Appl. No.: 19/225,107

(22) Filed: Jun. 2, 2025

(30) Foreign Application Priority Data
Jul. 9, 2024 (KR) 10-2024-0090476

(51) Int. Cl. G06V 20/40; G06V 10/762; G06V 40/10; G10L 25/78

(52) U.S. Cl. CPC G06V 20/41; G06V 10/762; G06V 40/10; G10L 25/78

(57) ABSTRACT

Tagging of people appearing in a video can be performed more efficiently by grouping people appearing in the video by utilizing image data and audio data in the video together. It is possible to solve the problems of the prior art that had difficulty in searching for people appearing in a video or to analyze and edit scenes in which these people appear, and to maximize the efficiency of video editing and searching.

### CROSS REFERENCE TO RELATED APPLICATION AND CLAIM OF PRIORITY

This application claims the benefit under 35 USC § 119 of Korean Patent Application No. 10-2024-0090476 filed on Jul. 9, 2024 in the Korean Intellectual Property Office, the entire disclosure of which is incorporated herein by reference for all purposes.

### BACKGROUND

### 1. Field of the Invention

Embodiments of the present disclosure relate to a technology for tagging a video based on artificial intelligence.

### 2. Description of the Related Art

Generally, videos filmed for production of broadcasts, movies, dramas, etc. are delivered to editors through personal delivery such as a quick service. Recently, in order to reduce such inefficiency, a service for uploading videos filmed at filming sites to cloud storage based on cloud services is being developed.

However, despite the development of such cloud services, editors still spend a lot of time in a video editing process. The videos filmed for the production of the broadcasts, movies, dramas, etc. described above are numerous and large in capacity, and thus it is inevitable that a lot of time and money will be spent in the editing process.

In addition, since the videos edited in this way are numerous and large in capacity, it is very difficult to search for specific people or dialogues in the videos.

### SUMMARY

Embodiments of the present disclosure provide a means for more easily tagging people and dialogue in a video to improve efficiency and convenience in a video editing or search process.

In accordance with an exemplary embodiment of the present invention, there is provided a system for tagging a video based on artificial intelligence including a video collection unit configured to collect a video, a preprocessing unit configured to separate image data and audio data within the video, an image clustering unit configured to detect person images from the image data and cluster person images of the same person among the detected person images to generate a plurality of different image groups, an audio clustering unit configured to detect speech sections from the audio data and cluster speech sections of the same person among the detected speech sections to generate a plurality of different audio groups, a group matching unit configured to acquire a speech score indicating a probability value of whether each of person images in each image group has spoken by inputting the person images into a set speaker detection model based on artificial intelligence, select a person image whose speech score is greater than or equal to a reference value, match the selected person image and a speech section corresponding to the selected person image and connect the selected person and the speech section to each other with a speaker matching line, determine and match an image group and an audio group for the same person based on the number of speaker matching lines each connecting the image group and the audio group to each other and a total sum of speech scores each corresponding to each speaker matching line, and a group tagging unit configured to tag the image group and the audio group for the same person, in which the speaker detection model is configured to output the speech score as a probability value within a set range by using at least one of a mouth shape, gesture, and facial expression of the person images included in each image group, and the group matching unit is configured to determine the image group and audio group for the same person based on a first condition on whether the number of the speaker matching lines each connecting the image group and the audio group satisfies a set first threshold or more, a second condition on whether a ratio of the number of the speaker matching lines each connected to the image group to the number of the person images included in the image group satisfies a second threshold or more, and a third condition on whether the total sum of the speech scores each corresponding to each speaker matching line connecting the image group and the audio group satisfies a third threshold or more.

The group tagging unit may be configured to receive a tag of the image group and audio group for the same person from a user, and tag the image group and audio group for the same person with the tag.

The image clustering unit may be configured to remove an image group composed of less than a set number of person images from among the plurality of image groups, and the audio clustering unit may be configured to remove an audio group composed of speech sections whose total speech time is less than a set time from among the plurality of audio groups.

In accordance with an exemplary embodiment of the present invention, there is provided a method for tagging a video based on artificial intelligence including collecting, by a video collection unit, a video, separating, by a preprocessing unit, image data and audio data within the video, detecting, by an image clustering unit, person images from the image data, clustering, by the image clustering unit, person images of the same person among the detected person images to generate a plurality of different image groups, detecting, by an audio clustering unit, speech sections from the audio data, clustering, by the audio clustering unit, speech sections of the same person among the detected speech sections to generate a plurality of different audio groups, acquiring, by a group matching unit, a speech score indicating a probability value of whether each of person images in each image group has spoken by inputting the person images into a set speaker detection model based on artificial intelligence, selecting, by the group matching unit, a person image whose speech score is greater than or equal to a reference value, matching, by the group matching unit, the selected person image and a speech section corresponding to the selected person image and connects the selected person and speech section to each other with a speaker matching line, determining and matching, by the group matching unit, an image group and an audio group for the same person based on the number of speaker matching lines each connecting the image group and the audio group to each other and a total sum of the speech scores each corresponding to each speaker matching line, and tagging, by a group tagging unit, the image group and the audio group for the same person, in which the speaker detection model is configured to output the speech score as a probability value within a set range by using at least one of a mouth shape, gesture, and facial expression of the person images included in each image group, and, in the determining and matching of the image group and the audio group for the same person, the image group and audio group for the same person is determined based on a first condition on whether the number of speaker matching lines each connecting the image group and the audio group satisfies a set first threshold or more, a second condition on whether a ratio of the number of speaker matching line each connected to the image group to the number of person images included in the image group satisfies a second threshold or more, and a third condition on whether the total sum of the speech scores each corresponding to each speaker matching line connecting the image group and the audio group satisfies a third threshold or more.

In the tagging of the image group and the audio group for the same person, a tag of the image group and audio group for the same person may be received from a user, and the image group and audio group for the same person may be tagged with the tag.

The method for tagging the video based on artificial intelligence may further include, before the acquiring of the speech score, removing, by the image clustering unit, an image group composed of less than a set number of person images from among the plurality of image groups, and removing, by the audio clustering unit, an audio group composed of speech sections whose total speech time is less than a set time from among the plurality of audio groups.

### BRIEF DESCRIPTION OF THE DRAWINGS

Exemplary embodiments can be understood in more detail from the following description taken in conjunction with the accompanying drawings, in which:

FIG. 1 is a block diagram illustrating a detailed configuration of a system for tagging a video in accordance with exemplary embodiment of the present invention;

FIG. 2 is an exemplary diagram illustrating a process of separating image data and audio data within a video by a preprocessing unit in accordance with an exemplary embodiment of the present invention;

FIG. 3 is an exemplary diagram illustrating a process of generating a plurality of image groups by an image clustering unit in accordance with the exemplary embodiment of the present invention;

FIG. 4 is an exemplary diagram illustrating a process of generating a plurality of audio groups by an audio clustering unit in accordance with the exemplary embodiment of the present invention;

FIG. 5 is an exemplary diagram illustrating a process of outputting a speech score through a speaker detection model by a group matching unit in accordance with the exemplary embodiment of the present invention;

FIG. 6 is an exemplary diagram illustrating a process of matching an image group and an audio group by the group matching unit in accordance with the exemplary embodiment of the present invention;

FIG. 7 is an exemplary diagram illustrating a process of tagging an image group and an audio group for the same person by a tagging unit in accordance with the exemplary embodiment of the present invention;

FIG. 8 is a flowchart for describing a method for tagging a video in accordance with another exemplary embodiment of the present invention; and

FIG. 9 is a block diagram for illustratively describing a computing environment including a computing device suitable for use in exemplary embodiments.

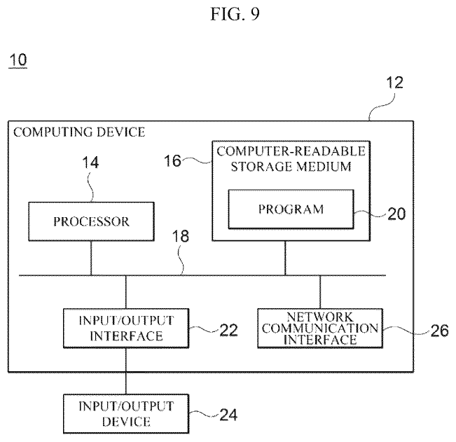

### DETAILED DESCRIPTION OF EMBODIMENTS

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In addition, in describing embodiments of the present disclosure, if it is determined that a specific description of a related known function of the preset disclosure may unnecessarily obscure the gist of the present disclosure, the detailed description thereof will be omitted. The terms described below are terms defined in consideration of the functions in the present disclosure, and may vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

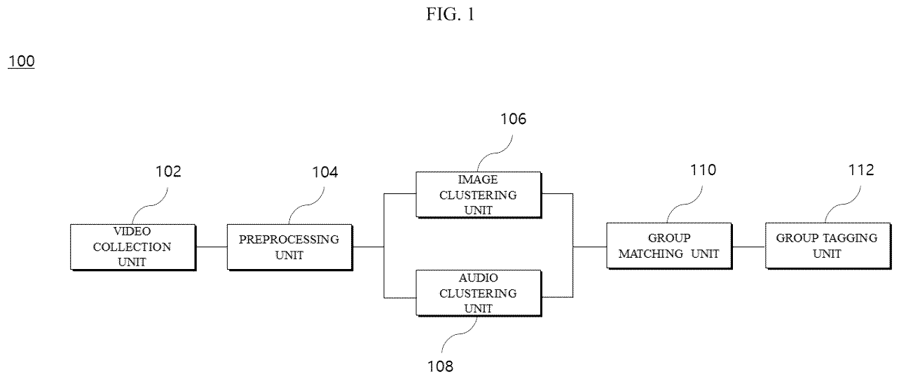

FIG. 1 is a block diagram illustrating a detailed configuration of a system for tagging a video 100 according to an embodiment of the present invention.

As illustrated in FIG. 1, the system 100 for tagging a video according to an embodiment of the present invention includes a video collection unit 102, a preprocessing unit 104, an image clustering unit 106, an audio clustering unit 108, a group matching unit 110, and a group tagging unit 112.

The video collection unit 102 collects a video to be tagged. The video collection unit 102 may, for example, receive a video from a user terminal (not illustrated) or collect a video from a set cloud storage (not illustrated). In the present embodiments, a video is composed of a combination of continuous image frames and audio, and may be, for example, a broadcasting video, a movie video, a drama video, etc. These videos may include multiple people and dialogues. The video collection unit 102 may collect a video to be tagged in various ways.

The preprocessing unit 104 separates image data and audio data within the video.

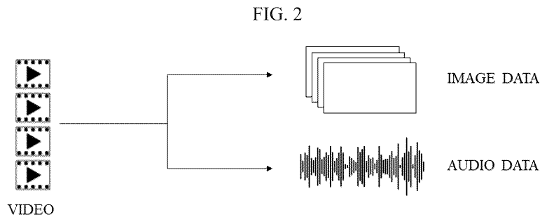

FIG. 2 is an exemplary diagram illustrating a process of separating the image data and audio data within the video by the preprocessing unit 104 according to an embodiment of the present invention.

Referring to FIG. 2, the preprocessing unit 104 may separate the video into image data and audio data. In this case, the image data may be composed of a plurality of continuous image frames, and each image frame may include one or more objects. Here, the objects may include both fixed objects such as buildings, roads, etc., and moving objects such as people, vehicles, etc. In addition, the audio data may include people's dialogue, background music, background sounds (e.g., wind sounds, rain sounds, etc.), etc. The preprocessing unit 104 may separate image data and audio data within the video by utilizing image extraction techniques, audio extraction techniques, etc., which are generally widely known in the technical field of the present invention.

Returning to FIG. 1 again, the image clustering unit 106 generates a plurality of image groups from the image data.

To this end, the image clustering unit 106 may detect person images from the image data. As an example, the image clustering unit 106 may detect person images from the image data by utilizing various algorithms such as histograms of oriented gradients (HOG), Haar cascade classifier, etc. However, the method of detecting person images by the image clustering unit 106 is not limited thereto, and the image clustering unit 106 may detect person images by utilizing various face recognition algorithms, pedestrian detection algorithms, etc.

Next, the image clustering unit 106 clusters the person images of the same person among the detected person images to generate a plurality of different image groups. The image clustering unit 106 may extract image features of the detected person images and cluster the person images of the same person based on the extracted image features. Here, the image features may be, for example, facial features, body proportions, etc. within the person image. As an example, the image clustering unit 106 may cluster the person images having image features whose similarity is greater than or equal to a reference value. The image clustering unit 106 may generate a plurality of different image groups by clustering the person images of the same person in this manner. In this case, each image group may include one or more person images, and the number of person images included in each image group may be different.

The audio clustering unit 108 generates a plurality of audio groups from audio data.

To this end, the audio clustering unit 108 may detect speech sections from audio data. As an example, the audio clustering unit 108 may detect speech sections having features corresponding to speech of a person while scanning the entire section of audio data. Specifically, the audio clustering unit 108 may extract sections in which sound sources exist within audio data, remove background music, background sounds, etc. from the extracted sections, and then detect speech sections that have features corresponding to the person's speech, i.e., dialogue sections. The audio clustering unit 108 may detect speech sections by comparing previously trained training data with sections in which sound sources exist.

Next, the audio clustering unit 108 clusters speech sections of the same person among the detected speech sections to generate a plurality of different audio groups. The audio clustering unit 108 may extract audio features of detected speech sections and cluster speech sections of the same person based on the extracted audio features. Here, the audio features may be, for example, the tone, pitch, etc. of audio within the speech section. Since the audio features are different for each speaker, the audio clustering unit 108 may cluster speech sections of the same person based on the extracted audio features.

As an example, the audio clustering unit 108 may cluster speech sections having audio features whose similarity is greater than or equal to a reference value. The audio clustering unit 108 may cluster speech sections of the same person in this way to generate a plurality of different audio groups. In this case, each audio group may include one or more speech sections, and the number of speech sections and the speech time included in each audio group and the speech time may be different from each other. Here, each speech section may be divided temporarily.

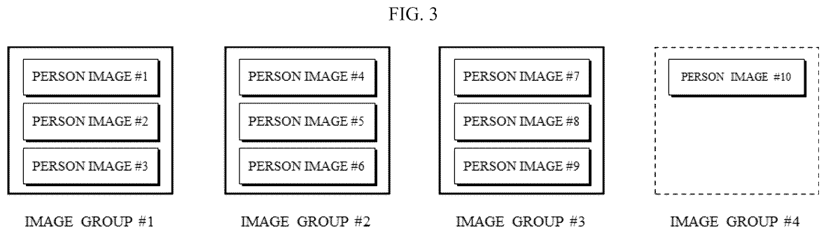

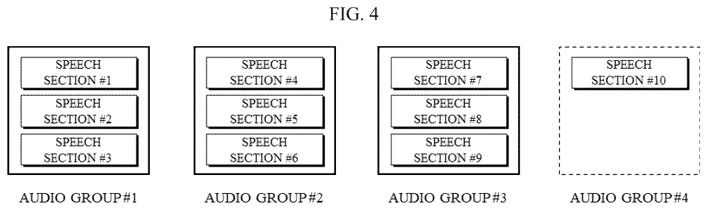

FIG. 3 is an exemplary diagram illustrating a process of generating a plurality of image groups by the image clustering unit 106 according to an embodiment of the present invention, and FIG. 4 is an exemplary diagram illustrating a process of generating a plurality of audio groups by the audio clustering unit 108 according to an embodiment of the present invention.

Referring to FIG. 3, the image clustering unit 106 may detect person images from image data, and cluster person images of the same person among the detected person images to generate a plurality of different image groups.

As an example, the image clustering unit 106 may detect person images #1 to #10, and cluster person images of the same person among the detected person images to generate image group #1, image group #2, image group #3, and image group #4. In this case, image group #1 includes person images #1 to #3, image group #2 includes person images #4 to #6, image group #3 includes person images #7 to #9, and image group #4 may include person image #10. That is, the image clustering unit 106 may determine that person image #1 to person image #3 are images of the same person and generate image group #1, determine that person image #4 to person image #6 are images of the same person and generate image group #2, determine that person images #7 to #9 are images of the same person and generate image group #3, and generate image group #4 including person image #10.

In this case, the image clustering unit 106 may remove an image group, which is composed of person images less than to a set number (a reference value), from among a plurality of image groups. In the example above, the image clustering unit 106 may remove image group #4 that contains only person image #10. As described below, a matching operation may be performed between each grouped image group and each grouped audio group. In this case, if an audio matching operation is performed for all the people appearing in the video, it may take a very long time. Accordingly, the image clustering unit 106 may remove an image group composed of person images less than a set number so that the matching operation may be performed only on people who frequently appear in the video. The person images within the image group removed in this way may be, for example, an image of an extra actor playing the role of a passerby.

Meanwhile, the number of person images that serve as a criterion for removing an image group may be set by the administrator, but may also be dynamically determined according to the number of image groups extracted from the image clustering unit 106, an average of the number of person images included in each image group, etc. As an example, the number of person images that serve as a criterion for removing an image group may increase, as the number of image groups extracted from the image clustering unit 106 increases and the average of the number of person images included in each image group increases. That is, as the number of people who frequently appear in the video (e.g., main characters) increases, the set number increases, and the probability that person images of people that appear relatively less frequently in the video video will be removed increases.

In addition, referring to FIG. 4, the audio clustering unit 108 may detect speech sections from audio data and cluster speech sections of the same person among the detected speech sections to generate a plurality of different audio groups.

As an example, the audio clustering unit 108 may detect speech section #1 to segment #10 and cluster speech sections of the same person among the detected speech sections to generate audio group #1, audio group #2, audio group #3, and audio group #4. In this case, audio group #1 includes speech section #1 to speech section #3, audio group #2 includes speech section #4 to speech section #6, audio group #3 includes speech section #7 to speech section #9, and audio group #4 may include speech section #10. That is, the audio clustering unit 108 may determine that speech section #1 to speech section #3 are audio for the same person and generate audio group #1, determine that speech section #4 to speech section #4 are audio for the same person and generate audio group #2, determine that speech section #7 to speech section #9 are audio for the same person and generate audio group #3, and generate audio group #4 including speech section #10.

In this case, the audio clustering unit 108 may remove an audio group composed of speech sections whose total reference speech time is less than the set time from among a plurality of audio groups. In the above example, the audio clustering unit 108 may remove audio group #4 including only speech section #10. As described above, a matching operation may be performed between each grouped image group and each grouped audio group. In this case, if the image matching operation is performed for all speech sections existing in the video, it may take a very long time. Accordingly, the audio clustering unit 108 may remove an audio group composed of speech sections having a total speech time less than the set time so that the matching operation may be performed only for a person who frequently speaks in the video.

Meanwhile, the total speech time that serves as the criterion for removing the audio group may be set by the administrator, but may also be dynamically determined based on the number of speech sections extracted by the audio clustering unit 108, the average of the total speech times of the speech sections included in each audio group, etc. As an example, the total speech time that serves as the criterion for removing the audio group may increase, as the number of speech sections extracted by the audio clustering unit 108 increases and the average of the total speech times of the speech sections included in each audio group increases. That is, as the number of people who speak frequently in a video increases or the total speech time of the person who appears frequently in the video increases, the total speech time (the reference speech time) that serves as the criterion for removing the audio group may also increase.

Returning to FIG. 1 again, the group matching unit 110 determines the image group and audio group for the same person based on the correlation between a plurality of image groups and a plurality of audio groups and matches the image groups and the audio groups with each other. The correlation between the image group and the audio group may be determined by a connection form of a speaker matching line described below and a speech score corresponding to the speaker matching line.

Specifically, the group matching unit 110 input the person images included in each image group into a set speaker detection model based on artificial intelligence to acquire the speech score indicating whether each person image has spoken, and select a person image whose speech score is greater than or equal to a reference value. In addition, the group matching unit 110 may match the selected person image and a speech section corresponding to the selected person image and connects the speech sections with the speaker matching line, and determine the image group and audio group for the same person based on the speaker matching line and matches the image group and the audio group.

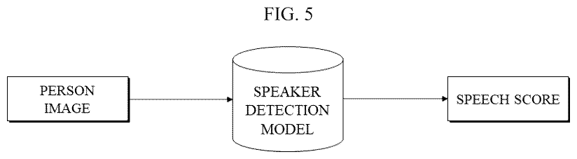

FIG. 5 is an exemplary diagram illustrating a process of outputting a speech score through a speaker detection model by the group matching unit 110 according to an embodiment of the present invention.

Referring to FIG. 5, the group matching unit 110 may acquire a speech score indicating whether each person image has spoken by inputting the person images included in each image group into the speaker detection model. Here, the speaker detection model may be configured to output the speech score as a numerical value within a set range by using at least one of a mouth shape, gesture, and facial expression of the person images included in each image group. The speaker detection model may determine the similarity by comparing at least one of the mouth shape, gesture, and facial expression of the person images included in each image group with previously trained training data, for example. The speaker detection model may output the speech score as a probability value for whether the person images included in each image group are currently speaking according to the similarity. For example, the speaker detection model may be configured to output a higher speech score as the similarity increases. The speech score may have a value between approximately 0 and approximately 1, for example. The group matching unit 110 may acquire the speech score for each of the person images included in the image group using the speaker detection model. As an example, in the case of a person image with a speech score of approximately 0.98, it means that the probability that the person included in the person image is currently speaking is approximately 98%.

Thereafter, the group matching unit 110 may select a person image having a speech score greater than or equal to a reference value. As an example, the group matching unit 110 may select a person image having a speech score greater than or equal to 0.7.

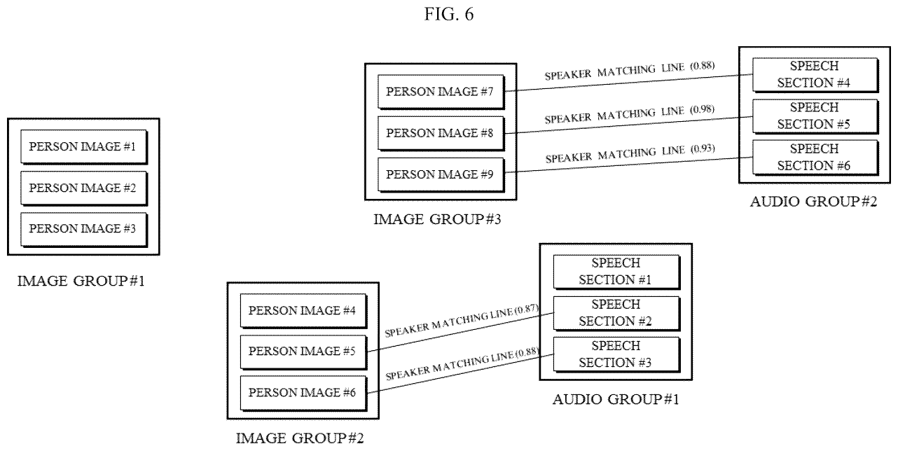

FIG. 6 is an exemplary diagram illustrating a process of matching an image group and an audio group by the group matching unit 110 according to an embodiment of the present invention.

Referring to FIG. 6, the group matching unit 110 may match the selected person image and the speech section corresponding to the selected person image to each other and connect the selected person image and the speech section with a speaker matching line. That is, the group matching unit 110 may extract a time zone of an image frame including a person image having a speech score greater than or equal to the reference value, and match the speech section corresponding to the extracted time zone (i.e., a speech section of the same time zone as the extracted time zone) with the person image. The group matching unit 110 may connect the person image and speech section matched in this way with the speaker matching line. That is, the speaker matching line may be generated only when i) the speech score for a specific person image is greater than or equal to the reference value, and ii) a speech section of the same time zone as the time zone from which the specific person image is extracted exists. Here, the same time zone is interpreted in a broad sense to include not only the exact same time zone but also the same time zone within a set error range.

As an example, when the time zone of an image frame including person image #5 included in image group #2 is approximately 1 minute 30 seconds to approximately 1 minute 35 seconds of the video, the group matching unit 110 may match speech section #2 in the time zone of approximately 1 minute 30 seconds to approximately 1 minute 35 seconds of the video with person image #5 and connect speech section #2 and person image #5 to each other with a speaker matching line.

As another example, when the time zone of an image frame including person image #6 included in image group #2 is approximately 2 minutes 40 seconds to approximately 2 minutes 45 seconds of the video, the group matching unit 110 may match speech section #3 in the time zone of approximately 2 minutes 40 seconds to approximately 2 minutes 45 seconds of the video with person image #6 and connect speech section #3 and person image #6 to each other with a speaker matching line.

As illustrated in FIG. 6, it may be confirmed that person image #5 and speech section #2 are connected to and matched with each other through a speaker matching line (0.87), and person image #6 and speech section #3 are connected to and matched with each other through a speaker matching line (0.88). Here, approximately 0.87 and approximately 0.88 represent the speech scores described above.

In this case, some person images and some speech sections may not match with each other due to incorrect clustering by the image clustering unit 106 or the audio clustering unit 108. In addition, the person image and the speech section may be incorrectly connected to each other through the speaker matching line. Accordingly, the group matching unit 110 may determine whether the connected image group and audio group are groups regarding the same person based on the connection form of the speaker matching line connected between the image group and the audio group and the speech score corresponding to the speaker matching line.

Specifically, the group matching unit 110 may determine the image group and audio group for the same person based on at least one of the number of speaker matching lines each connecting the image group and the audio group and a total sum of the speech scores each corresponding to each speaker matching line. That is, the group matching unit 110 may determine the image group and audio group for the same person based on at least one of set first condition to third condition.

Here, the first condition is whether the number of speaker matching lines each connecting the image group and the audio group satisfies a first threshold or more, for example, whether the number of speaker matching lines each connecting the image group and the audio group satisfies approximately 2 or more. As an example, since the number of speaker matching lines each connecting image group #3 and audio group #2 is approximately 3, the group matching unit 110 may determine that image group #3 and audio group #2 are groups regarding the same person.

The second condition is whether a ratio of the number of speaker matching lines each connected to the image group to the number of person images included in the image group satisfies a second threshold or more, for example, whether the ratio of the number of speaker matching lines each connected to the image group to the number of person images included in the image group satisfies 0.8 or more. As an example, since the ratio of the number of speaker matching lines (approximately 3) each connected to the image group #3 to the number of person images (approximately 3) included in the image group #3 is approximately 1, the group matching unit 110 may determine that image group #3 and audio group #2 are groups regarding the same person.

The third condition is whether the total sum of the speech scores each corresponding to each speaker matching line connecting the image group and the audio group satisfies a third threshold or more, for example, whether the total sum of the speech scores each corresponding to each speaker matching line connecting the image group and the audio group satisfies approximately 2.0 or more. As an example, since the total sum of the speech scores each corresponding to each speaker matching line connecting image group #3 and audio group #2 is approximately 0.88+approximately 0.98+approximately 0.93=approximately 2.79, the group matching unit 110 may determine that image group #3 and audio group #2 are groups regarding the same person.

In this way, the group matching unit 110 may determine the image group and audio group for the same person based on at least one of the number of speaker matching lines each connecting the image group and the audio group and the total sum of the speech scores each corresponding to each speaker matching line, and accordingly, even when some errors occur in the clustering process or the process of connecting individual speaker matching lines, the matching accuracy between the image group and the audio group for the same person may be further improved.

Returning to FIG. 1 again, the group tagging unit 112 tags the image group and audio group for the same person determined by the group matching unit 110. To this end, the group tagging unit 112 may receive a tag of the image group and audio group for the same person from a user, and tag the image group and audio group for the same person with the tag.

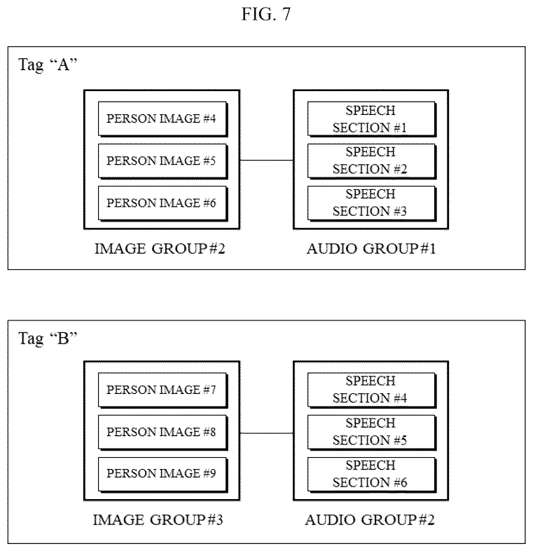

FIG. 7 is an exemplary diagram illustrating a process of tagging an image group and an audio group for the same person by the tagging unit 112 according to an embodiment of the present invention.

Referring to FIG. 7, the tagging unit 112 may receive a tag “A” from a user for image group #2-and-audio group #1, and tag image group #2-and-audio group #1 with the tag “A”.

In addition, the tagging unit 112 may receive a tag “B” from a user for image group #3-and-audio group #2, and tag image group #3-and-audio group #2 with the tag “B”. Here, the tag may be, for example, a person's name, role, etc.

In this way, the tagging unit 112 may perform tagging by receiving a tag for an image group-audio group for the same person from the user. That is, according to the embodiments of the present invention, people and dialogues appearing in the video can be tagged in a simpler and easier way, thereby improving the efficiency and convenience in the video editing or search process.

Whether a specific person in the video has had a certain conversation is a very important factor in video search and may also be used for scene analysis. However, in the past, there was a problem that it was difficult to learn by directly tagging the dialogue of the people appearing in the video, and most of the prior art focused on clustering people through image matching, which resulted in low search efficiency and limitations in scene analysis. According to the embodiments of the present invention, tagging of people appearing in the video can be performed more efficiently by grouping the people appearing in the video by using both image data and audio data within the video. In this case, it is possible to solve the problem of the prior art that it was difficult to search for people appearing in the video or analyze and edit scenes in which these people appear, and to maximize the efficiency of video editing and searching.

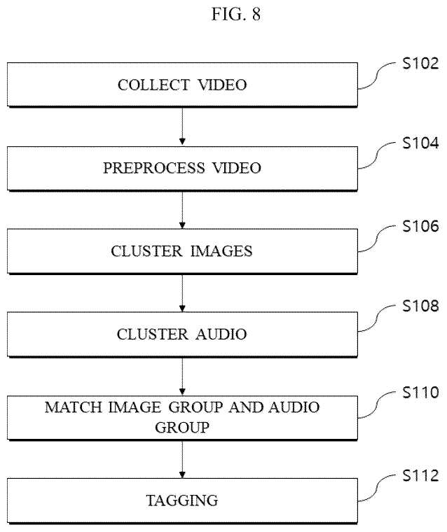

FIG. 8 is a flowchart for describing a method for tagging a video in accordance with another exemplary embodiment of the present invention. In the illustrated flowchart, the above method is described by being divided into a plurality of steps, but at least some of the steps may be performed in a different order, combined with other steps and performed together, omitted, performed by being divided into sub-steps, or performed by being added with one or more steps (not illustrated).

In step S102, the image collection unit 102 collects a video.

In step S104, the preprocessing unit 104 separates image data and audio data within the video.

In step S106, the image clustering unit 106 detects person images from the image data, and clusters person images of the same person among the detected person images to generate a plurality of different image groups.

In step S108, the audio clustering unit 108 detects speech sections from the audio data, and clusters speech sections of the same person among the detected speech sections to generate a plurality of different audio groups.

In step S110, the group matching unit 110 matches an image group and audio group for the same person. Specifically, the group matching unit 110 may acquire a speech score indicating whether each person image has spoken by inputting the person images included in each image group into a speaker detection model, and select a person image whose speech score is greater than or equal to a reference value. In addition, the group matching unit 110 may extract a speech section corresponding to an image frame including the selected person image among the detected speech sections, match the extracted speech section and selected person image with each other and connect the speech section and the person image to each other with a speaker matching line, determine and match an image group and an audio group for the same person based on the speaker matching line.

In step S112, the tagging unit 112 tags the image group and the audio group for the same person.

FIG. 8 is a block diagram illustrating a computing environment including a computing device suitable for use in exemplary embodiment. In the illustrated embodiment, respective components may have different functions and capabilities other than those described below, and may include additional components in addition to those described below.

An illustrated computing environment 10 includes a computing device 12. In an embodiment, the computing device 12 may be the system for tagging a video 100, or one or more components included in the system for tagging a video 100.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to embodiments of the present invention, tagging of people appearing in a video can be performed more efficiently by grouping people appearing in the video by utilizing image data and audio data in the video together. In this case, it is possible to solve the problems of the prior art that had difficulty in searching for people appearing in a video or to analyze and edit scenes in which these people appear, and to maximize the efficiency of video editing and searching.

Although the present disclosure has been described in detail through representative embodiments above, those skilled in the art will understand that various modifications may be made to the embodiments described above without departing from the scope of the present invention. Therefore, the scope of the rights of the present invention should not be limited to the described embodiments, but should be determined by the claims described below as well as equivalents of the claims.

What is claimed is:

1. A system for tagging a video based on artificial intelligence, comprising:
a video collection unit configured to collect a video;
a preprocessing unit configured to separate image data and audio data within the video;
an image clustering unit configured to detect person images from the image data and cluster person images of the same person among the detected person images to generate a plurality of different image groups;
an audio clustering unit configured to detect speech sections from the audio data and cluster speech sections of the same person among the detected speech sections to generate a plurality of different audio groups;
a group matching unit configured to acquire a speech score indicating a probability value of whether each of person images in each image group has spoken by inputting the person images into a set speaker detection model based on artificial intelligence, select a person image whose speech score is greater than or equal to a reference value, match the selected person image and a speech section corresponding to the selected person image and connect the selected person and the speech section to each other with a speaker matching line, determine and match an image group and an audio group for the same person based on the speaker matching line; and
a group tagging unit configured to tag the image group and the audio group for the same person.

2. The system of claim 1, wherein the speaker detection model is configured to output the speech score as a probability value within a set range by using at least one of a mouth shape, gesture, and facial expression of the person images included in each image group.

3. The system of claim 1, wherein the group matching unit is configured to determine an image group and an audio group for the same person based on the number of speaker matching lines each connecting the image group and the audio group to each other and a total sum of speech scores each corresponding to each speaker matching line.

4. The system of claim 3, wherein the group matching unit is configured to determine the image group and audio group for the same person based on a first condition on whether the number of the speaker matching lines each connecting the image group and the audio group satisfies a set first threshold or more, a second condition on whether a ratio of the number of the speaker matching lines each connected to the image group to the number of the person images included in the image group satisfies a second threshold or more, and a third condition on whether the total sum of the speech scores each corresponding to each speaker matching line connecting the image group and the audio group satisfies a third threshold or more.

5. The system of claim 1, wherein the group tagging unit is configured to receive a tag of the image group and audio group for the same person from a user, and tag the image group and audio group for the same person with the tag.

6. The system of claim 1, wherein the image clustering unit is configured to remove an image group composed of less than a set number of person images from among the plurality of image groups, and
the audio clustering unit is configured to remove an audio group composed of speech sections whose total speech time is less than a set time from among the plurality of audio groups.

7. A method for tagging a video based on artificial intelligence, comprising:
collecting, by a video collection unit, a video;
separating, by a preprocessing unit, image data and audio data within the video;
detecting, by an image clustering unit, person images from the image data;
clustering, by the image clustering unit, person images of the same person among the detected person images to generate a plurality of different image groups;
detecting, by an audio clustering unit, speech sections from the audio data;
clustering, by the audio clustering unit, speech sections of the same person among the detected speech sections to generate a plurality of different audio groups;
acquiring, by a group matching unit, a speech score indicating a probability value of whether each of person images in each image group has spoken by inputting the person images into a set speaker detection model based on artificial intelligence;
selecting, by the group matching unit, a person image whose speech score is greater than or equal to a reference value;
matching, by the group matching unit, the selected person image and a speech section corresponding to the selected person image and connects the selected person and speech section to each other with a speaker matching line;
determining and matching, by the group matching unit, an image group and an audio group for the same person based on the speaker matching line; and
tagging, by a group tagging unit, the image group and the audio group for the same person.

8. The method of claim 7, wherein the speaker detection model is configured to output the speech score as a probability value within a set range by using at least one of a mouth shape, gesture, and facial expression of the person images included in each image group.

9. The method of claim 7, wherein, in the matching of the image group and the audio group for the same person based on the speaker matching line, an image group and an audio group for the same person is determined based on the number of speaker matching lines each connecting the image group and the audio group to each other and a total sum of speech scores each corresponding to each speaker matching line.

10. The method of claim 9, wherein, in the matching of the image group and the audio group for the same person based on the speaker matching line, the image group and audio group for the same person is determined based on a first condition on whether the number of speaker matching lines each connecting the image group and the audio group satisfies a set first threshold or more, a second condition on whether a ratio of the number of speaker matching line each connected to the image group to the number of person images included in the image group satisfies a second threshold or more, and a third condition on whether the total sum of the speech scores each corresponding to each speaker matching line connecting the image group and the audio group satisfies a third threshold or more.

11. The method of claim 7, wherein, in the tagging of the image group and the audio group for the same person, a tag of the image group and audio group for the same person is received from a user, and the image group and audio group for the same person is tagged with the tag.

12. The method of claim 7, further comprising:
before the acquiring of the speech score,
removing, by the image clustering unit, an image group composed of less than a set number of person images from among the plurality of image groups; and
removing, by the audio clustering unit, an audio group composed of speech sections whose total speech time is less than a set time from among the plurality of audio groups.
